(19) United States
(12) Patent Application Publication
(10) Pub. No.: US 2025/0277154 A1
(43) Pub. Date: Sep. 4, 2025

(54) EXTERNALLY HEATED COIL FOR HYDROCARBON CRACKING

(71) Applicant: NOVA CHEMICALS (INTERNATIONAL) S.A., Fribourg (CH)

(72) Inventors: Jeffrey CROWE, NW Calgary (CA); Eric CLAVELLE, SE Calgary (CA)

(73) Assignee: NOVA CHEMICALS (INTERNATIONAL) S.A., Fribourg (CH)

(21) Appl. No.: 18/857,874

(22) PCT Filed: Feb. 10, 2023
(86) PCT No.: PCT/IB2023/051217

§ 371 Date: Oct. 18, 2024

Related U.S. Application Data
(60) Provisional application No. 63/333,368, filed on Apr. 21, 2022.

(51) Int. Cl. C10G 9/20; B01J 19/00; B01J 19/24

(52) U.S. Cl. CPC C10G 9/206; B01J 19/0013; B01J 19/244; B01J 2219/00092; B01J 2219/00103; B01J 2219/00135; B01J 2219/00157

(57) ABSTRACT

An apparatus for hydrocarbon cracking includes a reactor and a heating component. The reactor has an interior cavity configured to receive a feed stream. The feed stream includes a hydrocarbon. The heating component surrounds the reactor. The heating component is configured to provide heat to an external surface of the reactor to crack the hydrocarbon and produce a product stream. The product stream includes a C2-C4 alkene, syngas, or a combination thereof. The reactor is configured to discharge the product stream. The heating component can include an electrical resistor, a combustion chamber, or both.

### TECHNICAL FIELD

This disclosure relates to hydrocarbon cracking.

### BACKGROUND ART

Hydrocarbon cracking and reforming involves the breakdown of complex organic molecules, such as kerogens or long-chain hydrocarbons, into simpler molecules, such as light hydrocarbons. The breakdown of the organic molecules includes the breaking of carbon-carbon bonds. The rate of cracking and composition of the end-products of cracking can be dependent on operating temperature of the cracking process. The manner in which heating is provided to the hydrocarbons to reach the desired operating temperature can be a factor to consider in hydrocarbon cracking and reforming processes. For example, in several conventional cracking processes, heat is generated by combustion of fuel in a gas-fired furnace, which can negatively impact the carbon footprint and can contribute to greenhouse gas emissions. Further, in some cases, it can be difficult to achieve fine temperature control across the length of a cracking reactor when heat is generated by fuel combustion.

### SUMMARY OF INVENTION

This disclosure describes technologies relating to hydrocarbon cracking.

In a first aspect, an apparatus for hydrocarbon cracking includes a reactor and a heating component. The reactor has an interior cavity configured to receive a feed stream. The feed stream includes a hydrocarbon. The heating component surrounds the reactor. The heating component is configured to provide heat to an external surface of the reactor to crack the hydrocarbon and produce a product stream. The product stream includes a C2-C4 alkene, syngas, or a combination thereof. The reactor is configured to discharge the product stream.

This, and other aspects, can include one or more of the following features. The heating component can include an electrical resistor that is configured to produce the heat provided to the external surface of the reactor in response to receiving electrical power. The electrical resistor can be metallic. The electrical resistor can be embedded in ceramic. The electrical resister can be embedded in ceramic with a metallic sheath. The electrical resistor can include nichrome, KANTHAL®, cupronickel, or any combination thereof. The heating component can include a combustion chamber that is configured to receive and combust a hydrocarbon fuel stream to produce the heat provided to the external surface of the reactor. The heating component can at least partially surround a curved portion of the reactor. The heating component can at least partially surround a straight portion of the reactor. The heating component can at least partially surround a U-bend of the reactor. The heating component can at least partially surround an elbow of the reactor. At least a portion of the heating component can be straight. At least a portion of the heating component can be curved. The reactor can have a shape of a twisted tube. The reactor can have a shape of a Mixing Element Radiant Tube (MERT). The heating component can have a uniform axial profile. The heating component can have a non-uniform axial profile. The apparatus can include a quench exchanger that surrounds at least a portion of an exterior of the reactor. The quench exchanger can be configured to receive a cooling fluid and transfer heat from the reactor to the cooling fluid. The cooling fluid can include boiler feedwater. The quench exchanger can be located downstream of the heating component in relation to an overall flow direction of the feed stream through the reactor. The quench exchanger can be configured to flow the cooling fluid in a parallel-flow configuration in relation to an overall flow direction of the feed stream through the reactor. The quench exchanger can be configured to flow the cooling fluid in a cross-flow configuration in relation to an overall flow direction of the feed stream through the reactor. The quench exchanger can be configured to flow the cooling fluid in a counter-flow configuration in relation to an overall flow direction of the feed stream through the reactor. The heating component can include a first end and a second end. The first end of the heating component can be connected to an electrical power source. The second end of the heating component can be free. The second end of the heating component can be connected to the reactor. The second end of the heating component can be connected to the electrical power source. The heating component can have a cylindrical shape. The heating component can include a hollow tube. The heating component can have a helical shape. The heating component can have a linear shape. The heating component can have a rectangular shape. The heating component can be configured to provide uniform circumferential heating to the external surface of the reactor. The heating component can be configured to provide non-uniform heating to the external surface of the reactor in an axial direction with respect to the reactor. The apparatus can include an insulating material that surrounds at least a portion of an external surface of the heating component.

In a second aspect, a system for hydrocarbon cracking includes a feed stream and any implementation of the first aspect (apparatus). The feed stream includes a hydrocarbon.

This, and other aspects, can include one or more of the following features. The feed stream can include naphtha, liquefied petroleum gas, ethane, propane, butane, or any combination thereof. The feed stream can include water. The product stream can include ethylene, propylene, butene, or any combination thereof. The feed stream can have a temperature from 115° C. to 1200° C., from 450° C. to 1100° C., or from 650° C. to 1000° C. The feed stream can have a residence time within the reactor from 0.02 seconds(s) to 4.5 s, from 0.1 s to 2.5 s, or from 0.1 s to 1.25 s. The reactor can be configured to discharge the product stream at a pressure from 15 kilopascals gauge (kPag) to 250 kPag, from 25 kPag to 200 kPag, or from 50 kPag to 120 kPag.

In a third aspect, a method for hydrocarbon cracking includes flowing a feed stream to an interior cavity of a reactor of an apparatus (for example, an implementation of the first aspect). The feed stream includes a hydrocarbon. The apparatus includes a heating component surrounding the reactor. The method includes providing, by the heating component, heat to an external surface of the reactor to crack the hydrocarbon (of the feed stream) and produce a product stream. The product stream includes a C2-C4 alkene, syngas, or a combination thereof. The method includes discharging the product stream from the reactor.

This and other aspects, can include one or more of the following features. The heating component can include an electrical resistor connected to an electrical power source. Providing the heat to the external surface of the reactor can include providing, by the electrical power source, power to the electrical resistor and converting, by the electrical resistor, the power to heat in response to receiving the power. The heating component can include a combustion chamber. Providing the heat to the external surface of the reactor can include flowing a hydrocarbon fuel stream to the combustion chamber and combusting the hydrocarbon fuel stream within the combustion chamber to produce the heat provided to the external surface of the reactor. The feed stream can be flowed to the interior cavity of the reactor, such that the feed stream has a residence time within the reactor rom 0.02 s to 4.5 s. An exterior of the heating component can operate at a temperature from 600° C. to 1100° C. The method can include measuring a temperature (for example, using a thermocouple) of an exterior of the heating component. The method can include measuring a temperature (for example, using a thermocouple or a heat gun) of a wall of the reactor. The interior cavity of the reactor can operate at a temperature from 600° C. to 1100° C., from 850° C. to 1100° C., or from 600° C. to 850° C. in response to the heating component providing the heat to the external surface of the reactor. An insulating material can surround at least a portion of an external surface of the heating component. The insulating material can include a cellular glass. The feed stream can include naphtha, liquefied petroleum gas, ethane, propane, butane, or any combination thereof. The product stream can include ethylene, propylene, butene, or any combination thereof. The feed stream can include water. The product stream can be discharged from the reactor at a pressure from 15 kPag to 250 kPag.

The details of one or more implementations of the subject matter of this disclosure are set forth in the accompanying drawings and the description. Other features, aspects, and advantages of the subject matter will become apparent from the description, the drawings, and the claims.

### BRIEF DESCRIPTION OF THE FIGURES

FIG. 1A is a perspective view of an example apparatus for hydrocarbon cracking.

FIG. 1B is a cross-sectional view of the apparatus of FIG. 1A.

FIG. 2 is a plot of surface heat flux versus reactor length for a reactor for hydrocarbon cracking and two example heating components.

FIG. 3 is a plot of reactor wall temperature versus reactor length for a reactor for hydrocarbon cracking and two example heating components.

### DESCRIPTION OF EMBODIMENTS

This disclosure provides an apparatus and method for hydrocarbon cracking. An apparatus includes a reactor and a heating component surrounding the reactor. The heating component is configured to provide heat to an exterior of the reactor, which is used to crack a hydrocarbon flowing through an interior cavity of the reactor. In some implementations, the heating component includes an electrical resistor that produces heat in response to receiving power. The heating component can have any shape, such as a cylindrical shape, a helical shape, a linear shape, or a rectangular shape. In some implementations, the heating component is configured to provide substantially uniform heating to the external surface of the reactor. For example, the heating component provides substantially uniform circumferential heating to the external surface of the reactor. In some implementations, the heating component is configured to provide non-uniform heating to the external surface of the reactor. For example, the heating component provides non-uniform heating to the external surface of the reactor in an axial direction. In some implementations, the heating component is configured to provide substantially uniform heating to the external surface of the reactor in a first direction and non-uniform heating to the external surface of the reactor in a second direction. For example, the heating component provides substantially uniform circumferential heating to the external surface of the reactor and optionally uniform heating to the external surface of the reactor in the axial direction.

The subject matter described in this disclosure can be implemented in particular implementations, so as to realize one or more of the following advantages. The apparatuses, systems, and methods described can be implemented to mitigate or prevent the formation of carbon-based fouling (also referred as coke) associated with hydrocracking processes. Fouling can negatively impact the hydrocracking processes, for example, fouling can reduce furnace surface area availability damage coatings, and negatively impact surface treatment in hydrocracking processing equipment. The apparatuses, systems, and methods described can be implemented to reduce the temperature of the reactor, which can reduce creep, increase material allowable stress, reduce thermal degradation, or any combination of these. This reduction in temperature of the reactor can allow for a reduction in wall thickness, an increase in service life, and use of a lower cost material grade for the tube. The apparatuses, systems, and methods described can reduce the production of hot spots, cold spots, or both in hydrocracking processing equipment. For example, the apparatuses, systems, and methods described can be implemented to provide consistent heat to a hydrocarbon stream. In some implementations, the heating component provides uniform heating to the hydrocarbon cracking reactor, thereby improving heat transfer per unit length. In some implementations, the apparatuses, systems, and methods described provide a tailored axial heating to a hydrocarbon stream. The tailored axial heating can be uniform or non-uniform along a length of the heating component to achieve process goals. The tailored axial heating can be advantageous for reaction kinetics and lead to increased selectivity and yield of preferred products in the hydrocarbon cracking process.

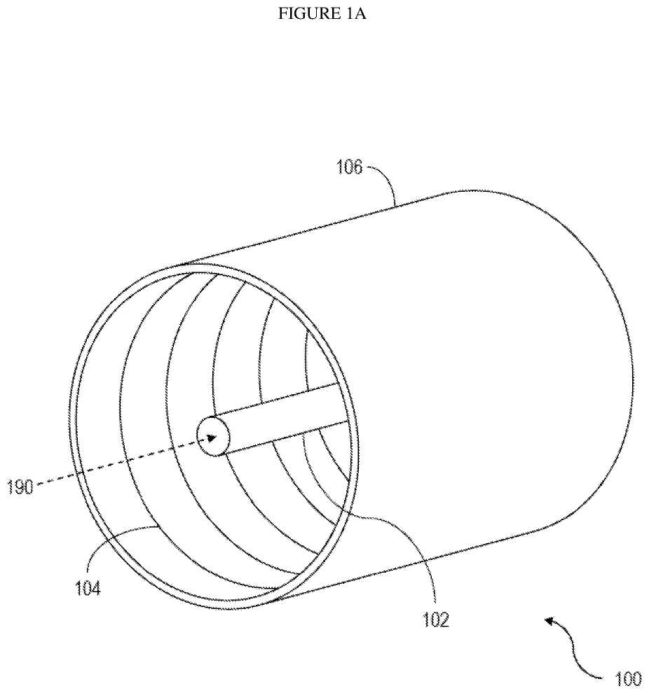

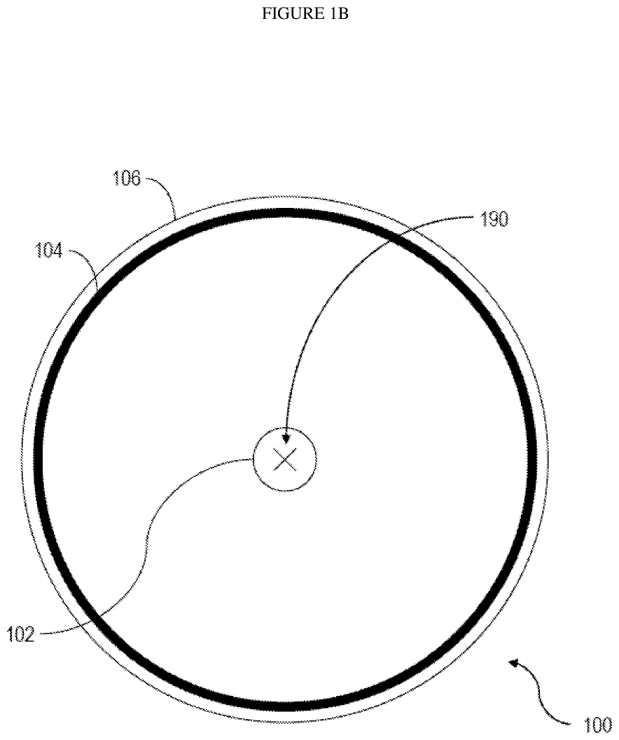

FIGS. 1A and 1B show a perspective view and a cross-sectional view, respectively, of an example apparatus 100 for hydrocarbon cracking. The apparatus 100 can be used, for example, in a hydrocracking process. The apparatus 100 includes a reactor 102 and a heating component 104. The reactor 102 has an interior cavity configured to receive a feed stream 190. The shape and dimensions of the reactor 102 are selected for cracking of hydrocarbons in the feed stream 190. The feed stream 190 flowing through the interior cavity of the reactor 102 is represented by the dotted arrow in FIG. 1A and the “x” in FIG. 1B. The feed stream 190 includes a hydrocarbon. The heating component 104 surrounds the reactor 102. The heating component 104 is configured to provide heat to an external surface of the reactor 102 to crack the hydrocarbon (from the feed stream 190) and produce a C2-C4 alkene, syngas, or a combination of these. Syngas is a gas mixture typically including hydrogen and carbon monoxide. Syngas can also include other gases, such as carbon dioxide. The volume (annulus) between the reactor 102 and the heating component 104 can be filled with a gas that does not impede heat transfer, and in particular, radiant heat transfer. For example, the volume between the reactor 102 and the heating component 104 can be filled with air or an inert gas, such as nitrogen. The dimensions of the volume between the reactor 102 and the heating component 104 and/or the fluid properties of the gas filling that volume can be adjusted to optimize heat transfer from the heating component 104 to the reactor 102. For example, the dimensions of the volume between the reactor 102 and the heating component 104 and/or the fluid properties of the gas filling that volume can be adjusted to optimize convective heat transfer from the heating component 104 to the reactor 102.

In some implementations, the feed stream 190 to the hydrocarbon cracking process includes naphtha, liquefied petroleum gas, ethane, propane, butane, or any combination thereof. In some implementations, the heating component 104 is configured to provide heat to the feed stream 190 flowing within the reactor 102, such that the feed stream 190 has a temperature from about 115° C. to about 1200° C., from about 450° C. to about 1100° C., or from about 650° C. to about 1000° C. In some implementations, the feed stream 190 has a residence time in the reactor 102 from about 0.02 s to about 4.5 s, from about 0.05 s to about 4.5 s, from about 0.1 s to about 2.5 s, or from about 0.1 s to about 1.25 s. In some implementations, the feed stream 190 has a pressure at an outlet of the reactor 102 from about 15 kPag to about 250 kPag, from about 25 kPag to about 250 kPag, from about 50 kPag to about 250 kPag, from about 15 kPag to about 200 kPag, from about 25 kPag to about 200 kPag, from about 50 kPag to about 200 kPag, from about 15 kPag to about 120 kPag, from about 25 kPag to about 120 kPag, or from about 50 kPag to about 120 kPag. In some implementations, the apparatus 100 is used to convert a hydrocarbon in the feed stream 190 to a C2-C4 alkene, syngas, or a combination of these. For example, the apparatus 100 is used to convert ethane in the feed stream 190 to ethylene. In some implementations, the hydrocarbon cracking process includes a steam cracker.

In some implementations, the reactor 102 has a low surface roughness on its inner surface which can minimize fouling. For example, the reactor 102 has a surface roughness less than 200 about pinch Ra or less than about 100 pinch Ra.

In some implementations, the reactor 102 is configured to increase heat transfer and homogenization of process gas temperature and concentration. The reactor 102 can have a high surface roughness to support heat flow. For example, the reactor 102 has a surface roughness greater than about 200 pinch Ra or greater than about 300 pinch Ra.

The reactor 102 can have any shape to facilitate heat transfer from the heating component 104 and into the interior cavity of the reactor 102 for cracking hydrocarbons. For example, the reactor 102 can have the shape of a twisted tube, which can increase mixing and heat transfer within the reactor 102. For example, the reactor 102 has the shape of a Mixing Element Radiant Tube (MERT, a technology developed by Kubota Materials Canada Corporation), which can increase mixing and heat transfer within the reactor 102. In some implementations, the reactor 102 is a hollow tube. For example, the reactor 102 is a cylindrical hollow tube or a helical hollow tube.

In some implementations, the reactor 102 has protuberances on its external surface, inner surface, or both, which can increase mixing and heat transfer within the reactor 102. For example, the reactor 102 includes fins which can increase the heat transfer surface area of the reactor 102, such as on its inner surface, on its external surface, or both. The reactor 102 can have a constant axial profile or a variable axial profile. The reactor 102 can include a coating. For example, the coating is applied to the inner surface of the reactor 102 to reduce fouling. The reactor 102 can be surface treated. For example, the surface treatment is applied to the reactor 102 to reduce fouling on the inner surface of the reactor 102.

In some implementations, the heating component 104 is made of a material that can be used to supply heat. For example, the heating component 104 is an electrical resistor that converts electricity into heat. The heating component 104 can include at least one metallic electrical resistance heating material. Some non-limiting examples of metallic electrical resistance heating materials include nichrome, KANTHAL®, cupronickel, or any combination thereof. The heating component 104 can include at least one ceramic heating material. Some non-limiting examples of ceramic heating materials include molybdenum disilicide and silicon nitride. The heating component 104 can be made from a material that is different from that of the reactor 102. For example, material selection for the heating component 104 can be optimized for heat generation and cost, while material selection for the reactor 102 can be optimized for heat transfer and resistance to fouling on its inner surface. The configuration of the apparatus 100 allows for each of the heating component 104 and the reactor 102 to be replaced or repaired at their own respective intervals, as required.

The heating component 104 can be installed around a tubular portion of the reactor 102, such as around U-bends, wyes, or elbows of the reactor 102. As another example, the heating component 104 runs a portion of the length of a straight portion of the reactor 102. The heating component 104 can be straight or curved. In some implementations, a first portion of the heating component 104 is straight, and a second portion of the heating component 104 is curved. The heating component 104 can run the length of reactor 102 or only a partial length of reactor 102. The heating component 104 can have any shape to facilitate radiative or convective heat transfer from the heating component 104 to the reactor 102. The heating component 104 can be a hollow tube. For example, the heating component 104 is a cylindrical hollow tube. The heating component 104 can be helical (for example, a helical wire). The heating component 104 may include parallel wires. The heating component 104 can have the shape of a rectangular prism.

In some implementations, the heating component 104 can also surround other components of the reactor 102, such as wyes or tees. For example, the heating component 104 surrounds a curved portion of the reactor 102. In some implementations, the heating component 104 surrounds a straight portion of the reactor 102. In some implementations, a first portion of the heating component 104 surrounds a straight portion of the reactor 102, and a second portion of the heating component 104 surrounds a curved portion of the reactor 102.

In some implementations, the heating component 104 can be used in a steam reforming reactor, which can also be referred to as a steam methane reformer. For example, the reactor 102 can be used as a steam reforming reactor. This reactor can be used to produce syngas by reaction of hydrocarbons with water in the presence of a catalyst. The catalyst is typically nickel-based. In some cases, the steam methane reformer (such as the reactor 102) includes tubes at least partially filled with a catalyst and disposed within a high temperature furnace. In some implementations, the tubes can be surrounded by an implementation of the heating component 104. The heating component 104 can provide some or all of the heating for the steam reforming process.

In some implementations, the apparatus 100 includes an insulating material 106. The insulating material 106 can surround at least a portion of an external surface of the heating component 104. In some implementations, the insulating material 106 encapsulates (that is, completely surrounds) the heating component 104. Such an enclosure provided by the insulating material 106 can provide protection to personnel and reduce losses to the environment, which can allow for optimizing heat transfer to the hydrocarbon cracking process occurring within the reactor 102. The insulating material 106 can maintain heat distribution to the external surface of the reactor 102. The insulating material 106 can maintain structural and/or metallurgical stability of the heating component 104. The insulating material 106 can provide a secondary containment for potential leakage of the hydrocarbon cracking process from the reactor 102. As such, the volume between the reactor 102 and the heating component 104 (for example, the inner volume of the encapsulating insulating material 106) can be monitored to detect loss of containment of the hydrocracking process from the reactor 102. In some implementations, the insulating material 106 includes cement. Some non-limiting examples of cement include KAOWOOL® White cement and FIBERFRAX® QF-180. In some implementations, the insulating material 106 includes ceramic fiber. Some non-limiting examples of ceramic fiber include KAOWOOL® blanket, CERABLANKET® AC2, FIBERFRAX® DURABACK®, INSULFRAX® S, FIBERFRAX® DURABLANKET® S, ISOFRAX® 1260C, and MAXSIL®. In some implementations, the insulating material 106 includes a loose fill and cushioning blanket. Some non-limiting examples of loose fill and cushioning blankets include KAOWOOL®, TEMP-MAT®, INSULFRAX® S, and MAXSIL®.

In some implementations, the heating component 104 includes a first end and a second end. In some implementations, the first end of the heating component 104 is connected to an electrical power source. In some implementations, the second end of the heating component 104 is connected to an electrical power source. In some implementations, the first end of the heating component 104 is free and not attached to another component. In some implementations, the second end of the heating component 104 is free and not attached to another component.

In some implementations, the heating component 104 is configured to provide uniform heat generation to the external surface of the reactor 102. In some implementations, the heating component 104 is configured to provide non-uniform heat generation to the external surface of the reactor 102. Non-uniform heat generation can provide the ability to control heat distribution along the cracking path for optimal cracking kinetics. Non-uniform heat generation can be accomplished by, for example, having a heating component 104 with multiple separate electrical elements within the heating component 104, each configured to supply different or the same heat inputs. Non-uniform heat generation can be accomplished by, for example, having the electrical resistance properties of the electrical conductor vary across the length of the heating component 104, for example, by varying diameter or conductor material.

Although shown in FIGS. 1A and 1B as including one heating component 104, the apparatus 100 can include multiple heating components 104. In some implementations, the apparatus 100 includes multiple heating components 104 that operate at different temperatures, such that the heating profile to the external surface of the reactor 102 can be fine-tuned. In some implementations, the apparatus 100 includes a furnace that operates in conjunction with the heating component 104. For example, the furnace operates at a temperature that provides heat similar to the heat provided by the heating component 104 to the external surface of the reactor 102.

A method for hydrocarbon cracking can be implemented by the apparatus 100. The method includes flowing a feed stream (such as feed stream 190) to an interior cavity of a reactor (such as reactor 102). Heat is generated by a heating component (such as heating component 104) surrounding the reactor 102 to crack the hydrocarbon from the feed stream 190 and produce a product stream that includes a C2-C4 alkene derived from the hydrocarbon, syngas, or a combination of these. The method includes discharging the product stream from the reactor 102.

### EXAMPLES

An example reactor for ethane pyrolysis was designed by optimizing residence time, temperature profile, pressure profile, heat flux profile, and steam to alkane ratio to obtain a desired alkane conversion and yield. As examples for this design process, two heating components surrounding a reaction reactor were designed to replace an existing, typical radiantly heated pyrolysis coil. Table 1 shows the typical dimensions and process conditions for a Millisecond Furnace (MSF) originally developed by M. W. Kellogg. The MSF has 152 coils, each with an inside diameter of 1.5 inches, an outside diameter of 2.01 inches, and a length within the radiant section of the furnace of 42 feet. The coils were operated with 37,000 pounds per hour (lb/hr) of ethane and 18,500 lb/hr of steam, which were pre-heated to a temperature of 705 degrees Celsius (° C.). The exit temperature of the pyrolysis gas (cracked gas) was 882° C.

TABLE 1
MSF Design and Operating Parameters

| | | |
|---|---|---|
| Coil Length | feet | 42.0 |
| Coil Inside Diameter | inches | 1.5 |
| Coil Outside Diameter | inches | 2.01 |
| Number of Pyrolysis Coils | | 152 |
| Ethane Inlet Flow Rate | lb/hr | 37,000 |
| Steam Inlet Flow Rate | lb/hr | 18,500 |
| Ethane and Steam Inlet Temperature | ° C. | 705 |
| Volume Within a Single Coil | cubic meters | 0.0146 |
| Residence Time of Gas Within Coil | seconds | 0.25 |

There are various ways to design the heating component and reactor. Two non-limiting examples are provided as implementations of these design methods. The examples retained the MSF coil dimensions and feed inlet conditions provided in Table 1. A computational fluid dynamics (CFD) model was created with the MSF geometry, chemistry, and heat transfer. The feed inlet conditions and heating profile of the reactor were specified upon solution of the CFD model, and the performance of the heated reactor was predicted. A CFD model for the MSF and examples were created. The MSF model implemented a heat flux profile typical of a radiant furnace heated by combustion burners.

Example 1 considered a heating component with a linearly decreasing heat flux applied to the external surface of the reactor. The heat flux was greatest at the inlet of the reactor and least at the outlet of the reactor. In Example 1, a maximum heat flux and a minimum heat flux were found to achieve the same overall heating rate to the reactor, while achieving equal ethylene production (at the MSF conditions provided in Table 1) but with a decreased reactor wall temperature. A heat flux value of 89.5 kilowatts per square meter (kW/m²) at the inlet of the reactor linearly decreasing to 12.5 kW/m² at the outlet of the reactor resulted in a total heat transfer to the reactor of 104.5 kW, matching the typical MSF operation.

Example 2 considered a heating component with a non-uniform heat flux applied to the external surface of the reactor. The design intent for Example 2 was to increase production of ethylene in comparison to the typical MSF while maintaining a cooler reactor wall temperature. The heating component of Example 2 supplied a constant external temperature of 1035° C. for the first 1 meter of reactor length, followed by an external temperature of 1010° C. for the remaining reactor length. In Example 2, heat input to the reactor from the heating component of Example 2 increased by about 12% in comparison to the typical MSF (117 kW versus 105 KW). Examples 1 and 2 differ in the chosen heat flux profiles, but both serve to show the flexibility allowed for process optimization and reactor wall temperature reduction for improving the operation of such pyrolysis chambers.

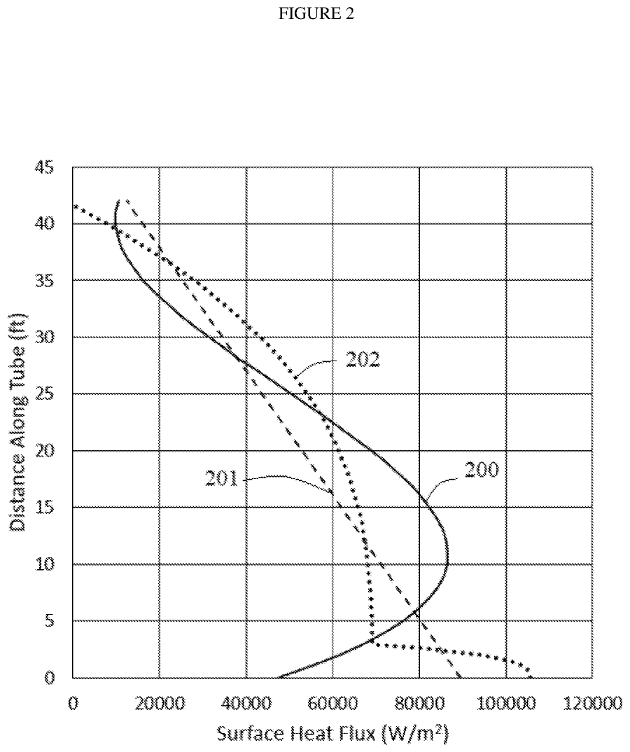

FIG. 2 shows a plot of the heat flux profile to the reactor external wall for a typical MSF, Example 1 at typical MSF operation, and Example 2 at typical MSF operation. The solid line 200 shows the non-uniform heat flux from combustion in a typical MSF. The dashed line 201 shows the linearly decreasing heat flux applied by the heating component of Example 1. The dotted line 202 shows the non-uniform heat flux applied by the heating component of Example 2.

TABLE 2
Results of CFD Model for Typical
MSF, Example 1, and Example 2

| | | MSF | Example 1 | Example 2 |
|---|---|---|---|---|
| Cracked Gas Exit | ° C. | 882 | 886 | 915 |
| Temperature | | | | |
| Total Heat Transfer | kW | 105 | 105 | 117 |
| to Single Coil | | | | |
| Ethane Conversion | % | 55 | 54 | 60 |
| Ethylene Yield by | % | 86 | 86 | 86 |
| Weight | | | | |
| Ethylene Production | | 16,950 | 16,790 | 18,420 |
| (152 Coils) | | | | |
| Severity | | 0.017 | 0.018 | 0.018 |
| Coil Inside | ° C. | 970 | 977 | 1001 |
| Average | | | | |
| Temperature | | | | |
| Coil Outside | ° C. | 981 | 988 | 1017 |
| Average | | | | |
| Temperature | | | | |
| Coil Inside | ° C. | 1099 | 1047 | 1028 |
| Maximum | | | | |
| Temperature | | | | |
| Coil Outside | ° C. | 1117 | 1063 | 1035 |
| Maximum | | | | |
| Temperature | | | | |

Table 2 shows selected CFD model results for the typical MSF pyrolysis reactor, for the reactor including the heating component of Example 1, and for the reactor including the heating component of Example 2. The MSF and the reactor with the heating component of Example 1 supplied the same overall heat to the pyrolysis reactor. Both also resulted in the same ethane conversion, ethylene yield, and total ethylene production. In comparison to the MSF, the reactor with the heating component of Example 1 exhibited a 4° C. increase in cracked gas exit temperature. Severity can be defined as the ratio of propylene to ethylene production. The MSF and the reactor with the heating component of Example 1 exhibited substantially similar severities.

The ethane conversion for the typical MSF was 55%, while the ethane conversion for the reactor including the heating component of Example 2 was 60%. The yield for the typical MSF and for the reactor including the heating component of Example 2 was the same at 86%. The reactor including the heating component of Example 2 exhibited an increase of about 9% in ethylene production in comparison to the typical MSF. The cracked gas exit temperature for the reactor including the heating component of Example 2 was 32° C. warmer in comparison to that of the typical MSF, but the severity for both remained the same.

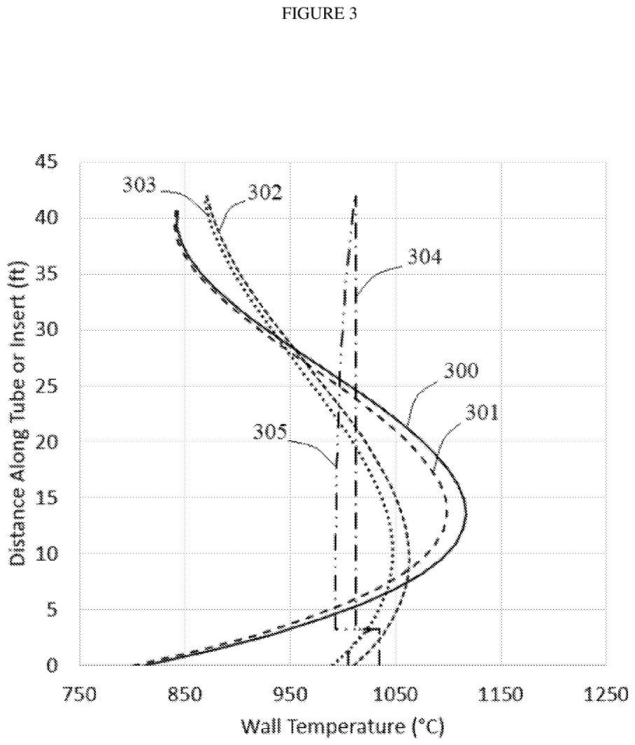

FIG. 3 shows a plot of the reactor wall temperature versus distance along the length of the reactor (reactor wall temperature profile) for the typical MSF, for the reactor including the heating component of Example 1, and for the reactor including the heating component of Example 2. The solid line 300 shows the outside reactor wall temperature profile of the typical MSF. The dashed line 301 shows the inside reactor wall temperature profile of the typical MSF. The short-dashed line 302 shows the outside reactor wall temperature profile of the reactor including the heating component of Example 1. The dotted line 303 shows the inside reactor wall temperature profile of the reactor including the heating component of Example 1. The average inside and outside reactor wall temperatures for the reactor with the heating component of Example 1 were both 7° C. warmer in comparison to those of the typical MSF. However, the maximum reactor wall temperature for the reactor with the heating component of Example 1 was more than 50° C. cooler in comparison to that of the MSF. Further, the temperature along the length of the reactor wall was more uniform for the reactor with the heating component of Example 1 in comparison to that of the MSF. As shown in FIG. 3, the typical MSF experiences greater extremes in wall temperatures in comparison to the reactor including the heating component of Example 1. The increased uniformity in reactor wall temperature and reduction in maximum reactor wall temperature (of Example 1) can be beneficial in extending reactor operating life, reducing coke formation, and increasing operating periods between decoking operations for maintenance, as operating life of the reactor can be limited by a maximum temperature experienced by the reactor wall as opposed to the average temperature.

The dash-dot line 304 shows the outside reactor wall temperature profile of the reactor including the heating component of Example 2. The dash-dot-dot line 305 shows the inside reactor wall temperature profile of the reactor including the heating component of Example 2. The average inside and outside reactor wall temperatures for the reactor with the heating component of Example 2 were 31° C. and 36° C. warmer, respectively, in comparison to those of the typical MSF. The reactor wall temperatures of Example 2 show that the average reactor wall temperatures were warmer than those of the typical MSF, but were also much more uniform in comparison to the typical MSF. The increased uniformity in reactor wall temperature (of Example 2) can be beneficial in extending reactor operating life, reducing coke formation, and increasing operating periods between decoking operations for maintenance, as operating life of the reactor can be limited by a maximum temperature experienced by the reactor wall as opposed to the average temperature.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the term “hydrocarbon” is used to include any organic compound made entirely of hydrogen and carbon atoms. For example, a hydrocarbon can be methane, ethane, propane, n-butane, isobutene, or any combination thereof. For example, a hydrocarbon can include an organic compound with 1-12 carbon atoms. For example, a hydrocarbon can include naphtha, liquefied petroleum gas, or any combination thereof.

As used in this disclosure, the terms “downstream” and “upstream” are used in relation to an overall flow direction of the feed stream 190 flowing through the apparatus 100.

As used in this disclosure, the term “hydrocarbon cracking process” is used to include a process designed to break down and/or crack hydrocarbons. For example, a hydrocarbon cracking process can include the use of a furnace designed to crack alkanes into alkenes. A hydrocarbon cracking process can include a chemical reaction. Some non-limiting examples of a hydrocarbon cracking process include pyrolysis and reforming. As used in this disclosure, the term “C2-C4 alkene” is used to include ethylene, propylene, α-butylene, cis-β-butylene, trans-β-butylene, isobutylene, or any combination thereof.

As used in this disclosure, the terms “tube” or “coil” are used to describe a chamber, which can be used to heat a fluid. For example, a coil may include an assembly of tubes, U-bends, wyes, and elbows.

As used in this disclosure, the term “wye” is used to include a fitting with three openings. A wye can join or create branch lines. For example, a wye is a waste-fitting tee in which a side inlet pipe can enter at approximately a 45° angle. For example, a standard wye is a Y-shaped fitting which allows a pipe to be joined to another at a 45° angle. For example, a wye can be used to split a branch line in two directions, such as the splitting of a main line into two smaller branches. While a 45° side inlet is typical, the inlet angle for a wye is not limited to 45°.

As used in this disclosure, the term “superalloy” is used to include an alloy that has the ability to operate at a high fraction of its melting point. Some characteristics typical of a superalloy include high mechanical strength, resistance to thermal creep deformation, high surface stability, and resistance to corrosion and/or oxidation.

As used in this disclosure, the term “refractory metal alloy” is used to include an alloy that is highly resistant to heat and wear. Some characteristics typical of a refractory metal alloy include high melting point (for example, above 2000° C.), high hardness at room temperature, and chemically inert.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B”. In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z”, unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

### INDUSTRIAL APPLICABILITY

The present disclosure relates to endothermic conversion of hydrocarbons.

Specifically, an apparatus for conversion of hydrocarbons using a reactor where heat is supplied externally using a heated component is described.

1. An apparatus for hydrocarbon cracking, the apparatus comprising:
a reactor having an interior cavity configured to receive a feed stream comprising a hydrocarbon; and
a heating component surrounding the reactor and configured to provide heat to an external surface of the reactor to crack the hydrocarbon and produce a product stream comprising a C2-C4 alkene, syngas, or a combination thereof, wherein the reactor is configured to discharge the product stream.

2. The apparatus of claim 1, wherein the heating component comprises an electrical resistor configured to produce the heat provided to the external surface of the reactor in response to receiving electrical power.

3. The apparatus of claim 2, wherein the electrical resistor is metallic.

4. The apparatus of claim 2, wherein the electrical resistor is embedded in ceramic.

5. The apparatus of claim 2, wherein the electrical resistor is embedded in ceramic with a metallic sheath.

6. The apparatus of claim 2, wherein the electrical resistor comprises nichrome, KANTHAL®, cupronickel, or any combination thereof.

7. The apparatus of claim 1, wherein the heating component comprises a combustion chamber configured to receive and combust a hydrocarbon fuel stream to produce the heat provided to the external surface of the reactor.

8. The apparatus of claim 1, wherein the heating component at least partially surrounds a curved portion of the reactor.

9. The apparatus of claim 1, wherein the heating component at least partially surrounds a straight portion of the reactor.

10. The apparatus of claim 1, wherein the heating component at least partially surrounds a U-bend of the reactor.

11. The apparatus of claim 1, wherein the heating component at least partially surrounds an elbow of the reactor.

12. The apparatus of claim 1, wherein at least a portion of the heating component is straight.

13. The apparatus of claim 1, wherein at least a portion of the heating component is curved.

14. The apparatus of claim 1, wherein the reactor has a shape of a twisted tube.

15. The apparatus of claim 1, wherein the reactor has a shape of a Mixing Element Radiant Tube (MERT).

16. The apparatus of claim 1, wherein the heating component has a uniform axial profile.

17. The apparatus of claim 1, wherein the heating component has a non-uniform axial profile.

18. The apparatus of claim 1, comprising a quench exchanger surrounding at least a portion of an exterior of the reactor, the quench exchanger configured to receive a cooling fluid and transfer heat from the reactor to the cooling fluid.

19. The apparatus of claim 18, wherein the cooling fluid comprises boiler feedwater.

20. The apparatus of claim 18, wherein the quench exchanger is located downstream of the heating component in relation to an overall flow direction of the feed stream through the reactor.

21. The apparatus of claim 18, wherein the quench exchanger is configured to flow the cooling fluid in a parallel-flow configuration in relation to an overall flow direction of the feed stream through the reactor.

22. The apparatus of claim 18, wherein the quench exchanger is configured to flow the cooling fluid in a cross-flow configuration in relation to an overall flow direction of the feed stream through the reactor.

23. The apparatus of claim 18, wherein the quench exchanger is configured to flow the cooling fluid in a counter-flow configuration in relation to an overall flow direction of the feed stream through the reactor.

24. The apparatus of claim 1, wherein the heating component comprises a first end and a second end.

25. The apparatus of claim 24, wherein the first end is connected to an electrical power source.

26. The apparatus of claim 24, wherein the second end is free.

27. The apparatus of claim 24, wherein the second end is connected to the reactor.

28. The apparatus of claim 24, wherein the second end is connected to the electrical power source.

29. The apparatus of claim 1, wherein the heating component has a cylindrical shape.

30. The apparatus of claim 1, wherein the heating component comprises a hollow tube.

31. The apparatus of claim 1, wherein the heating component has a helical shape.

32. The apparatus of claim 1, wherein the heating component has a linear shape.

33. The apparatus of claim 1, wherein the heating component has a rectangular shape.

34. The apparatus of claim 1, wherein the heating component is configured to provide uniform circumferential heating to the external surface of the reactor.

35. The apparatus of claim 1, wherein the heating component is configured to provide non-uniform heating to the external surface of the reactor in an axial direction with respect to the reactor.

36. The apparatus of claim 1, comprising an insulating material surrounding at least a portion of an external surface of the heating component.

37. A system for hydrocarbon cracking, the system comprising:
a feed stream comprising a hydrocarbon; and an apparatus of any one of claims 1 to 36.

38-49. (canceled)

50. A method for hydrocarbon cracking, the method comprising:
flowing a feed stream comprising a hydrocarbon to an interior cavity of a reactor of an apparatus, the apparatus comprising a heating component surrounding the reactor;
providing, by the heating component, heat to an external surface of the reactor to crack the hydrocarbon and produce a product stream comprising a C2-C4 alkene, syngas, or a combination thereof; and
discharging the product stream from the reactor.

51. The method of claim 50, wherein the heating component comprises an electrical resistor connected to an electrical power source, and providing heat to the external surface of the reactor comprises providing, by the electrical power source, power to the electrical resistor and converting, by the electrical resistor, the power to heat in response to receiving the power.

52. The method of claim 50, wherein the heating component comprises a combustion chamber, and providing heat to the external surface of the reactor comprises flowing a hydrocarbon fuel stream to the combustion chamber and combusting the hydrocarbon fuel stream within the combustion chamber to produce the heat provided to the external surface of the reactor.

53. The method of claim 50, wherein the feed stream is flowed to the interior cavity of the reactor, such that the feed stream has a residence time within the reactor from 0.02 s to 4.5 s.

54. The method of claim 50, wherein an exterior of the heating component operates at a temperature from 600° C. to 1100° C.

55. The method of claim 50, comprising measuring a temperature of an exterior of the heating component using a thermocouple.

56. The method of claim 50, comprising measuring a temperature of a wall of the reactor using a thermocouple.

57. The method of claim 50, comprising measuring a temperature of a wall of the reactor using a heat gun.

58. The method of claim 50, wherein the interior cavity of the reactor operates at a temperature from 600° C. to 1100° C. in response to the heating component providing heat to the external surface of the reactor.

59. The method of claim 50, wherein the interior cavity of the reactor operates at a temperature from 850° C. to 1100° C. in response to the heating component providing heat to the external surface of the reactor.

60. The method of claim 50, wherein the interior cavity of the reactor operates at a temperature from 600° C. to 850° C. in response to the heating component providing heat to the external surface of the reactor.

61. The method of claim 50, wherein an insulating material surrounds at least a portion of an external surface of the heating component.

62. The method of claim 61, wherein the insulating material comprises a cellular glass.

63. The method of claim 50, wherein the feed stream comprises naphtha, liquefied petroleum gas, ethane, propane, butane, or any combination thereof.

64. The method of claim 50, wherein the product stream comprises ethylene, propylene, butene, or any combination thereof.

65. The method of claim 50, wherein the feed stream comprises water.

66. The method of claim 50, wherein the product stream is discharged from the reactor at a pressure from 15 kPag to 250 kPag.
